(19) United States
(12) Patent Application Publication
(10) Pub. No.: US 2010/0182595 A1
(43) Pub. Date: Jul. 22, 2010

(54) THREE DIMENSIONAL LIGHT MEASURING APPARATUS

(76) Inventor: Min Jun Jang, Gyeonggi-Do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/516,169

(22) PCT Filed: May 23, 2007
(86) PCT No.: PCT/KR2007/002527

§ 371 Date: Mar. 11, 2010

(30) Foreign Application Priority Data
May 26, 2006 (KR) 10-2006-0047442

(51) Int. Cl. G01J 1/42; G01B 11/26

(52) U.S. Cl. 356/138

(57) ABSTRACT

A three dimensional light measuring apparatus, and more particularly, to a light measuring apparatus that three dimensionally measures the light emitted from an optical object without moving the optical object or the light measuring apparatus using a hemispherical scattering unit having a scattering layer is provided. The three dimensional light measuring apparatus includes a scattering unit including a scattering layer, a light sensing unit separated from the emission surface of the scattering unit by a predetermined distance to sense light emitted through the scattering unit, to convert the sensed light into an electrical signal, and to output the electrical signal, and a baffle that surrounds an edge of the incidence surface of the scattering unit to prevent external light from being radiated onto the incidence surface of the scattering unit, that forms a space so that the light emitted from the object is incident on the incidence surface of the scattering unit, and whose surface facing the incidence surface of the scattering unit is blackened to prevent the incident light from being reflected. The light measuring apparatus in which the hemispherical scattering unit having the scattering layer is used is provided so that it is possible to three dimensionally measure the light emitted from the optical object without rotating the optical object or the light measuring apparatus.

### TECHNICAL FIELD

The present invention relates to a three dimensional light measuring apparatus, and more particularly, to a light measuring apparatus that three dimensionally measures the light emitted from an optical object without moving the optical object or the light measuring apparatus using a hemispherical scattering unit having a scattering layer.

### BACKGROUND ART

Light is a part of various electron waves that exist in a space and is divided into X rays, ultraviolet (UV) rays, visible rays, and infrared rays.

Radiometry refers to measuring optical radiation and plays a very important role in various fields to which light is related. In particular, in order to measure the beam angle distribution of a light source such as a light emitting diode (LED) or the view angle of a display, the light emitted from the light source must be three dimensionally measured.

The conventional three dimensional light measuring apparatuses include an apparatus in which a goniometer that rotates a light source or a measuring instrument to three dimensionally measure light is used, an apparatus in which an integrating hemisphere and mirrors are used, and an apparatus in which fourier lenses are used.

In the light measuring apparatus where the goniometer is used, the light source or the measuring instrument must be rotated in order to measure the light three dimensionally emitted from the light source. Since the measuring instrument and the light source rotate to be separated from each other by a predetermined distance in the above apparatus, a large space is occupied so that there are many spatial limitations and it takes long to measure light so that it is difficult to apply the apparatus to a common industrial field.

In addition, in the light measuring apparatus where the integrating hemisphere and the mirrors are used, a plurality of shielding layers and mirrors are provided. Critical regions that cannot be measured exist due to the shielding layers and mirrors. Since the critical regions are compensated for as software, there is a difference in actual light distribution.

Since the light measuring apparatus in which the fourier lenses are used has a small measuring surface and uses a plurality of lenses, errors are generated by the alignment of optical systems or scattered light.

### DISCLOSURE OF INVENTION

### Technical Problem

Therefore, the present invention has been made in view of the above problems, and it is an aspect of the present invention to provide a three dimensional light measuring apparatus that can three dimensionally measure the light emitted from an optical object using a hemispherical scattering unit having a scattering layer without aligning optical systems and rotating the optical object or a measuring instrument.

### Technical Solution

In accordance with an aspect of the present invention, a three dimensional light measuring apparatus includes a scattering unit including an incidence surface that receives light emitted from an object whose light characteristic is to be measured, an emission surface that emits the incident light, and a scattering layer from which light that passes through the incidence surface and the emission surface is refracted and from which the light is scattered and a light sensing unit separated from the emission surface of the scattering unit by a predetermined distance and including an imaging sensor that senses an image focused on the scattering layer of the scattering unit, converts the image into an electrical signal, and outputs the electrical signal.

The three dimensional light measuring apparatus can further include a baffle that surrounds an edge of the incidence surface of the scattering unit to prevent external light from being radiated onto the incidence surface of the scattering unit, that forms a space so that the light emitted from the object is incident on the incidence surface of the scattering unit, and whose surface facing the incidence surface of the scattering unit is blackened to prevent the incident light from being reflected. In this case, a hole can be formed in the baffle so that the object is provided in the hole.

In addition, the scattering unit can be a flat plate or a trapezoid. In particular, the scattering unit is preferably hemispherical so that the emission surface is convex.

In addition, the scattering layer of the scattering unit is preferably formed on the emission surface. The scattering layer can be formed on one of the emission surface and the incidence surface or between the emission surface and the incidence surface. However, when the scattering layer is formed on the incidence surface or between the incidence surface and the emission surface, a part of the light scattered by the scattering layer is totally reflected by the scattering unit so that the light distribution form of the light source can be unclear.

In addition, the scattering unit of the three dimensional light measuring apparatus is preferably thicker toward an edge. When the angle at which light is incident from one medium to another medium is not perpendicular, a direction changes in a new medium. Such a phenomenon is referred to as refraction. The radiuses of the incidence surface and the emission surfaces of the scattering unit and the thickness of the scattering unit are controlled to move the light emitted from the object to the effective measurable region of the emission surface of the scattering unit using the refraction of light.

In addition, the optical object measured by the three dimensional light measuring apparatus can be a light emitting body such as a light emitting diode (LED) that emits light or a display. When the light emitting body is the LED, the LED is provided in the hole of the baffle to measure the light emitted by the LED and to measure the beam angle of the LED. In addition, when the light emitting body is the display, the light emitted from the display is measured to measure the three dimensional view angle of the display.

In addition, the optical object measured by the three dimensional light measuring apparatus can be a light reflecting object. That is, the three dimensional light measuring apparatus measures the light received by the light reflecting object to be three dimensionally reflected. In this case, the three dimensional light measuring apparatus further includes a light emitting unit that continuously emitting light to the light reflecting object while changing an altitude angle with respect to the light reflecting object so that the light reflected from the light reflecting object is emitted to the incidence surface of the scattering unit. A transmitting window is formed along a channel of the light in the scattering unit so that the light emitted from the light emitting unit passes through the transmitting window. Therefore, when the light reflecting object is provided in the hole formed in the baffle and light is emitted to the light reflecting object while changing an altitude angle by the light emitting unit, it is possible to measure the light reflected from the light reflecting object.

In addition, in this case, in the three dimensional light measuring apparatus, the transmitting window of the scattering unit can be formed of a lens, a hole, and a glass window. When the transmitting window is formed of the hole, the light emitted from the light emitting unit is not reflected or refracted but reaches the light reflecting object.

In addition, in this case, the light emitting unit of the three dimensional light measuring apparatus includes a light source device that emits light to the scattering unit in one direction and a projecting mirror that is in a linear motion in one direction of the light emitted from the light source device and that is in a rotary motion to reflect the light emitted from the light source device and to light the light reflecting object during the linear motion. In addition, the light source device can include a light source and at least one reflecting mirror that reflects the light emitted from the light source to the projecting mirror. Therefore, since the light emitted from the fixed light source can be projected to the measured object using the reflecting mirror and the projecting mirror, it is possible to solve spatial limitation.

In addition, the optical object measured by the three dimensional light measuring apparatus can be a light transmitting object. That is, the three dimensional light measuring apparatus measures the light received by the light transmitting object to be three dimensionally transmitted. In this case, it is preferable that the light emitting unit of the three dimensional light measuring apparatus is positioned outside the scattering unit and the baffle so that the light transmitted by the light transmitting object is emitted to the incidence surface of the scattering unit and that the light emitting unit continuously emits light to the light transmitting object while changing the altitude angle with respect to the light transmitting object.

### BRIEF DESCRIPTION OF THE DRAWINGS

FIG. 1 illustrates a three dimensional light measuring apparatus according to an embodiment of the present invention;

FIG. 2 illustrates a relationship between the curvature and the measured angle of a scattering unit according to the embodiment of FIG. 1;

FIG. 3 illustrates a relationship between the radius and the error measured angle of the scattering unit according to the embodiment of FIG. 1;

FIG. 4 illustrates a case in which an effective measurable region increases when the thickness of the scattering unit increases in an aperture according to the embodiment of FIG. 1;

FIG. 5 illustrates a case in which the scattering layer of the scattering unit is on an incidence surface and a case in which the scattering layer of the scattering unit is on an emission surface according to the embodiment of FIG. 1;

FIG. 6 illustrates a three dimensional light measuring apparatus according to another embodiment of the present invention; and

FIG. 7 illustrates a three dimensional light measuring apparatus according to still another embodiment of the present invention.

### DESCRIPTION OF THE ELEMENTS IN THE DRAWINGS

10: light sensing device
20: scattering unit
30: baffle
40: light source

### BEST MODE FOR CARRYING OUT THE INVENTION

Hereinafter, preferred embodiments of a three dimensional light measuring apparatus according to the present invention will be described in detail with reference to the accompanying drawings.

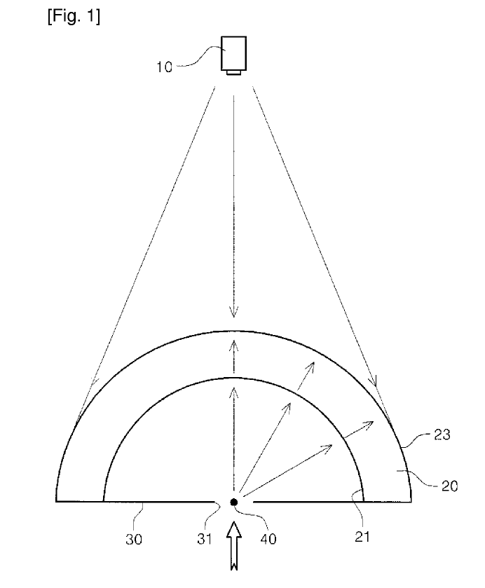

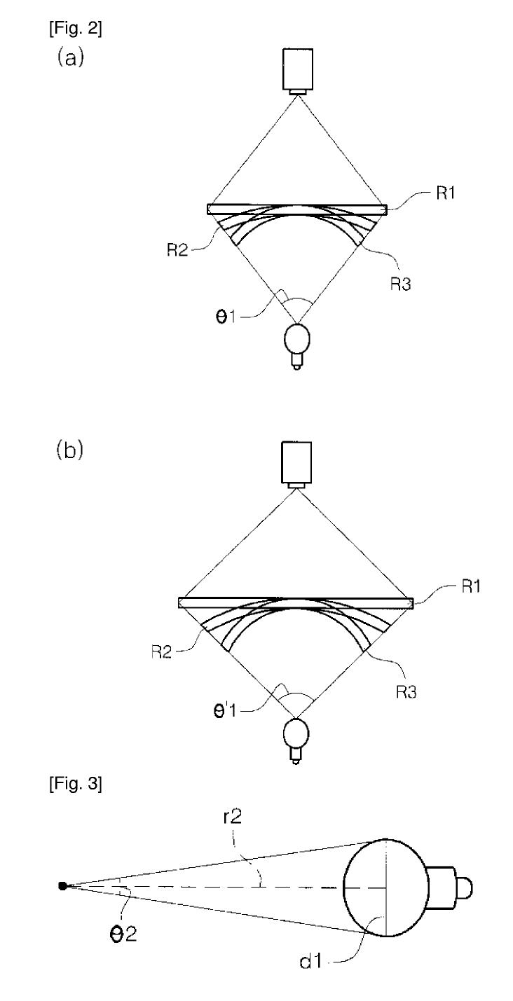

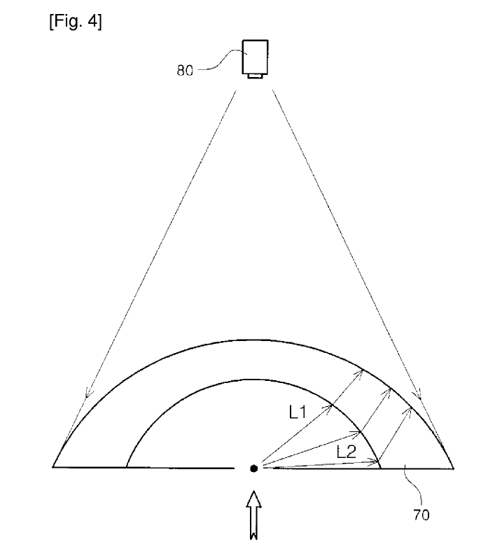

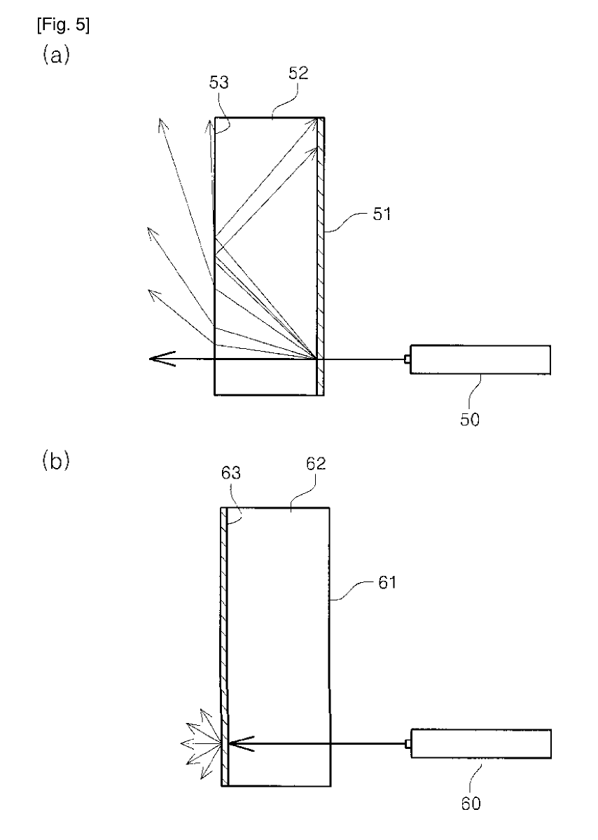

FIG. 1 illustrates a three dimensional light measuring apparatus according to an embodiment of the present invention. FIG. 2A illustrates the size of the image of the light projected to a scattering layer with respect to a change in the curvature of a scattering unit when a measured angle is q₁ according to the embodiment of FIG. 1. FIG. 2B illustrates the size of the image of the light projected to a scattering layer with respect to a change in the curvature of a scattering unit when a measured angle is q₁ according to the embodiment of FIG. 1. FIG. 3 illustrates a relationship between the radius and the error measured angle of the scattering unit according to the embodiment of FIG. 1. FIG. 4 illustrates a case in which an effective measurable region increases when the thickness of the scattering unit increases in an aperture according to the embodiment of FIG. 1. FIG. 5 illustrates a case in which the scattering layer of the scattering unit is on an incidence surface and a case in which the scattering layer of the scattering unit is on an emission surface according to the embodiment of FIG. 1. Hereinafter, description will be made with reference to FIGS. 1 to 5.

The three dimensional light measuring apparatus according to the present invention includes a light sensing device 10, a scattering unit 20, and a baffle 30.

The scattering unit 20 transmits the light emitted from a light source 40. The internal surface of the hemispherical scattering unit 20 is an incidence surface 21 on which the light emitted from the light source 40 is incident. The external surface of the hemispherical scattering unit 20 is an emission surface 23 from which the light is emitted. In addition, a scattering layer that scatters the light that passes through the incidence surface 21 and the emission surface 23 is formed on the emission surface 23. Therefore, the light emitted from the light source 40 passes through the incidence surface 21 of the scattering unit 20 and is primarily refracted by the incidence surface 21 of the scattering member 20 and the refracted light reaches the emission surface 23 of the scattering unit 20 to be scattered. A part of the scattered light is measured by the light sensing device 10. The light measured by the light sensing device 10 is converted into an electrical signal and is corrected as a final data value by an additional program (not shown). A hole 31 is formed in the center of the baffle 30 that is attached to the aperture of the scattering unit 20. Therefore, a light source 40 to be measure is positioned in the hole 31 formed in the center of the baffle 30 and it is possible to prevent light from being projected from an external light source to the incidence surface of the scattering unit 20 by the baffle 30. Hereinafter, the respective elements will be described in detail.

The light sensing device 10 measures light to convert the measured light into the electrical signal. The resolution and the dynamic range of the sensor used for the light sensing device 10 in order to measure the light are properly determined in accordance with the characteristics of the measured light.

The curvature, the radius, and the thickness of the scattering unit 20 and the position and the refractive index of the scattering layer can vary in accordance with the characteristics of the light measuring apparatus.

The curvature of the scattering unit 20 theoretically ranges from 0 to infinity. Referring to FIG. 2, R1 is obtained when the curvature is 0, R2 is obtained when the curvature is 25, and R3 is obtained when the curvature is 50. When the curvature of the scattering unit is small with respect to the same measured angle q₁, the size of the image of the light source to be measured that is projected to the scattering layer of the scattering unit increases. In a case where the measured angle increases from q₁ of FIG. 2A to q₁ of FIG. 2B, when the curvature of the scattering member is small, an amount by which the size of the image of the light source increases increases. Therefore, when the curvature is too small, since the image of the light to be measured that is projected to the scattering layer is too large with respect to a desired measured angle, it is difficult to apply the light measuring apparatus to actual measurement. Here, the measured angle refers to the angle formed by the image of the light projected to the scattering layer of the scattering unit 20 to be measured by the light sensing device 10 based on the light source 40. When the curvature is 0, a relationship between the size of the image and the measured angle is represented by Equation 1.

D=2R tan(θ/2) [EQUATION 1]

wherein, D represents the diameter of the image projected to the scattering layer, R represents the distance from the light source to the scattering unit, and q refers to the measured angle.

For example, when the distance between the light source and the scattering unit is 50 mm and when the measured angle is 120, the size of the image projected to the scattering layer is 173 mm.

In addition, when the light source to be measured is a point source, the light components that reach the scattering layer do not cross each other. However, the light source to be measured is not actually the point source but has a predetermined diameter. Therefore, the light components that reach the scattering layer cross each other so that a crossing region is generated in the scattering layer. Referring to FIG. 3, a measurement error angle q₂ can be obtained by Equation 2. Here, the measurement error angle q₂ is defined by the angle formed by the crossing region and the center point of the light source or the angle formed by the light source and one point of the scattering layer that is a measuring point.

θ₂=2 Tan⁻¹(d₁/2r₂) [EQUATION 2]

wherein, d₁ represents the diameter of the light source and r₂ represents the distance from the light source to the scattering unit.

Error is generated by the measurement error angle in the measured angle measured by the light sensing device. Therefore, accuracy increases as the measurement error angle is smaller and the accuracy is reduced as the measurement error angle is larger. The size of the measurement error angle varies with the radius of the scattering unit that is the size of the diameter of the light source and the distance from the light source to the scattering layer. That is, the measurement error angle increases as the radius of the scattering unit is smaller and the measurement error angle is reduced as the radius of the scattering member is larger. Therefore, the radius of the scattering unit must be determined to satisfy the measurement error angle.

When light passes through materials having different media at an angle that is not a right angle, refraction occurs. When the light passes through from the air that is a material having a low refractive index to the incidence surface of the scattering unit 20 that is a material having a high refractive index, a refraction angle is smaller than an incidence angle. Referring to FIG. 4, when the incidence angles of light L1 and light L2 that reach the incidence surface of a scattering unit 70 are different from each other, the refraction angles of the light L1 and the light L2 vary. Therefore, when the refractive index and the thickness of the scattering unit 70 are controlled, since the light L2 can be moved to an effective measurable region in which the light L2 can be measured by a light sensing device 80, the measured angle that can be measured by the light sensing device 80 increases.

In addition, according to the present embodiment, the scattering layer is formed on the emission surface of the scattering unit. Therefore, referring to FIG. 5B, the light that is perpendicularly incident on the incidence surface 61 of a scattering unit 62 has a transmittance no less than 99%. The transmitted light reaches the scattering layer of the emission surface 63 of the scattering unit 62 so that diffuse transmission occurs. In this case, the light distribution form of the light source is maintained in all observation directions.

Unlike in the present embodiment, as illustrated in FIG. 5A, the scattering layer can be formed on the incidence surface 51 of a scattering unit 52. When the scattering layer is formed on the incidence surface 51 of the scattering unit 52, the light that reaches the incidence surface 51 of the scattering unit 52 is scattered and is emitted to the emission surface 53 of the scattering unit 52. At this time, since the incidence surface 51 of the scattering unit 52 performs complete diffuse transmission, the light scattered to all azimuth angles reaches the emission surface 53 of the scattering unit 52. At this time, the light scattered to no less than a threshold angle is totally reflected from the emission surface of the scattering unit and the totally reflected light is secondarily scattered from the incidence surface of the scattering unit so that transmission and reflection occur. Therefore, the light distribution form of the light source is not maintained but becomes unclear.

In addition, the internal surface of the scattering unit is anti reflectance coated using sputtering or wet coating in order to prevent the light incident from the light source from being reflected so that the reflectance of the all azimuth angles is no more than 1%.

The baffle 30 is required for preventing the external light source from being received to the incidence surface of the scattering unit. In addition, the light emitted from the light source 40 passes through the scattering unit 20 to be measured by the light sensing device 10, however, partial light is reflected from the scattering unit 20 to the baffle 30. Therefore, the surface of the baffle is blackened in order to minimize the reflectance.

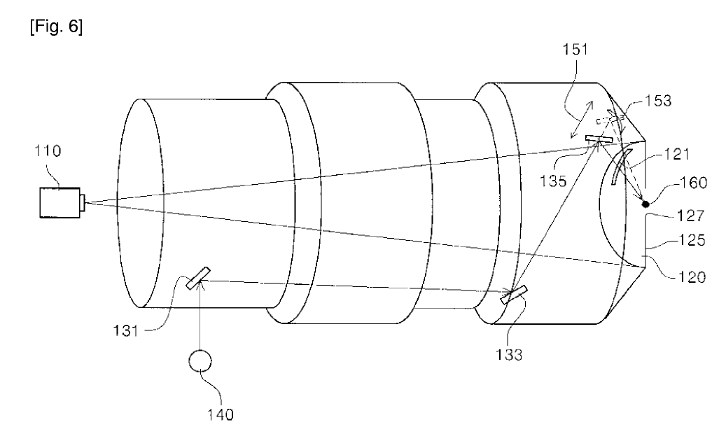

FIG. 6 illustrates a three dimensional light measuring apparatus according to another embodiment of the present invention. A light measuring apparatus according to the present embodiment includes a light sensing device 110, a scattering unit 120, a baffle 125, a light source 140, a first reflecting mirror 131, a second reflecting mirror 133, and a projecting mirror 135. The light measuring apparatus according to the embodiment of FIG. 1 is an apparatus for measuring the light directly emitted from the light source. However, the light measuring apparatus according to the present embodiment is an apparatus for projecting light from the light source 140 outside the scattering unit to the surface of a light reflecting object 160 positioned in the center of the baffle and for measuring the light reflected from the surface of the light reflecting object 160.

A bidirectional reflectance distribution function (BRDF) represents the reflectance by wavelength of the surface material of the light reflecting object 160 as a function with respect to two directions, that is, the direction of incident light and the direction of reflected light. In order to measure the BRDF with respect to the light reflecting object 160 by the light sensing device 110, a high dynamic range charge coupled device (CCD) sensor must be used to analyze a mirror surface reflecting component and haze and diffuse reflecting components. However, a low dynamic range CCD sensor can be used by controlling the transmittance of the region.

The light source 140 is positioned outside the scattering unit 120 and laser and halogen can be used as the light source 140. The light emitted from the light source 140 to the first reflecting mirror 131 is reflected from the first reflecting mirror 131 to the second reflecting mirror 133. The light reflected to the second reflecting mirror 133 is reflected to the scattering unit 120 again. The light reflected to the scattering unit 120 passes through the scattering unit 120 by the projecting mirror 135 and is projected to the light reflecting object 160 in a hole 127 in the center of the baffle 125. The light projected to the light reflecting object 160 is reflected to the scattering unit 120 again to be sensed by the light sensing device 110. That is, since the light reflecting object 160 receives light by the projecting mirror 135 to emit the received light to the scattering unit 120, the light reflecting object 160 operates as the light source in the scattering unit 120. Since the reflection characteristic of an object varies with an incidence angle, in order to measure the reflection characteristic of the light reflecting object 160, light must be projected to the light reflecting object 160 while changing the incidence angle. Therefore, the projecting mirror 135 can move in the direction of an arrow 151 along the channel of the light reflected by the second reflecting mirror. In addition, when the projecting mirror 135 moves along the channel of the light, the light reflected by the projecting mirror 135 is not projected to the center of the light reflecting object 160. Therefore, the projecting mirror 135 can rotate in the direction of an arrow 153 so that the light reflected by the projecting mirror 135 is projected to the center of the light reflecting object 160 while moving along the channel of the light.

A groove 121 is formed in the scattering unit 120 on the channel where light is projected from the projecting mirror 135 to the light reflecting object 160. Therefore, the light projected by the projecting mirror 135 passes through the scattering unit 120 to be projected to the light reflecting object 160.

According to the present embodiment, light is projected to the light reflecting object 160 using the light source 140, the first reflecting mirror 131, the second reflecting mirror 133, and the projecting mirror 135. However, light can be projected to the light reflecting object 160 using the light source 140, the first reflecting mirror 131, and the projecting mirror 135 or the light source 140 and the projecting mirror 135. In addition, the light source 140 can be mounted in the position of the projecting mirror 135 to directly project light to the light reflecting object 160.

FIG. 7 illustrates a three dimensional light measuring apparatus according to still another embodiment of the present invention. A bidirectional transmittance distribution function (BTDF) represents the transmittance by wavelength of the light transmitting object 240 as a function with respect to two directions, that is, the direction of incident light and the direction of transmitted light. The light measuring apparatus according to the embodiment of FIG. 6 is an apparatus for projecting light to the surface of the light reflecting object using the light source and for measuring the light reflected from the surface of the light reflecting object by the light. However, the light measuring apparatus according to the present embodiment is an apparatus for projecting light to the light transmitting object using the light source and for measuring the light transmitted by the light transmitting object. According to the present invention, the light measuring apparatus is an apparatus for measuring the BTDF with respect to the light transmitting object.

The light measuring apparatus according to the present embodiment includes a light sensing device 210, a scattering unit 220, a baffle 230, and a light source 250.

According to the embodiment of FIG. 1, a light emitting body such as a light emitting diode (LED) and a display is provided in the hole of the baffle. However, according to the present embodiment, the light transmitting object 240 is provided in the hole of the baffle. Since the light sensing device 210, the scattering unit 220, and the baffle 230 are the same as those illustrated in FIG. 1, the embodiment of FIG. 1 is referred to and detailed description of the light sensing device 210, the scattering unit 220, and the baffle 230 is omitted.

The light source 250 is positioned behind the light transmitting object 240 so that the light transmitted by the light transmitting object 240 is emitted to the incidence surface of the scattering unit 220. In addition, since the transmittance characteristic of an object varies with an incidence angle, in order to measure the transmittance characteristic of the light transmitting object 240, light must be projected to the light transmitting object 240 while changing the incidence angle. Therefore, the light source 250 can project light to the light transmitting object 240 while changing an altitude angle.

According to the present embodiment, light is projected to the light transmitting object 240 while changing the altitude angle using the light source 250 and the projected light passes through the light transmitting object 240 to be emitted to the incidence surface of the scattering unit 220. Therefore, it is possible to sense the light transmitted by the light sensing device 210.

### INDUSTRIAL APPLICABILITY

According to the present invention, there is provided a light measuring apparatus in which a hemispherical scattering unit having a scattering layer is used so that it is possible to three dimensionally measure the light emitted from an optical object without rotating the optical object or the light measuring apparatus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A three dimensional light measuring apparatus, comprising:
a scattering unit including an incidence surface that receives light emitted from an object whose light characteristic is to be measured, an emission surface that emits the incident light, and a scattering layer from which light that passes through the incidence surface and the emission surface is refracted and from which the light is scattered; and
a light sensing unit separated from the emission surface of the scattering unit by a predetermined distance and including an imaging sensor that senses an image focused on the scattering layer of the scattering unit, converts the image into an electrical signal, and outputs the electrical signal.

2. The three dimensional light measuring apparatus according to claim 1, further comprising a baffle that surrounds an edge of the incidence surface of the scattering unit to prevent external light from being radiated onto the incidence surface of the scattering unit, that forms a space so that the light emitted from the object is incident on the incidence surface of the scattering unit, and whose surface facing the incidence surface of the scattering unit is blackened to prevent the incident light from being reflected.

3. The three dimensional light measuring apparatus according claim 2, wherein a hole in which the object is provided is formed in the baffle.

4. The three dimensional light measuring apparatus according to claim 3, wherein the scattering unit is hemispherical so that the emission surface is convex.

5. The three dimensional light measuring apparatus according to claim 4, wherein the scattering layer of the scattering unit is formed on the emission surface.

6. The three dimensional light measuring apparatus according to claim 4, wherein the scattering layer of the scattering unit is formed on the incidence surface.

7. The three dimensional light measuring apparatus according to claim 6, wherein the scattering unit becomes thicker toward an edge.

8. The three dimensional light measuring apparatus according to claim 7, wherein the object is a light emitting diode (LED).

9. The three dimensional light measuring apparatus according to claim 1,
further comprising a light emitting unit that continuously emitting light to the light reflecting object while changing an altitude angle with respect to the light reflecting object so that the light reflected from the light reflecting object is emitted to the incidence surface of the scattering unit,
wherein the object is a light reflecting object, and
wherein a transmitting window is formed along a channel of the light in the scattering unit so that the light emitted from the light emitting unit passes through the transmitting window.

10. The three dimensional light measuring apparatus according to claim 9, wherein the transmitting window is formed of a hole.

11. The three dimensional light measuring apparatus according to claim 9, wherein the transmitting window is formed of a lens.

12. The three dimensional light measuring apparatus according to claim 9, wherein the light emitting unit comprises:
a light source device that emits light to the scattering unit in one direction; and
a projecting mirror that is in a linear motion in one direction of the light emitted from the light source device and that is in a rotary motion to reflect the light emitted from the light source device and to light the light reflecting object during the linear motion.

13. The three dimensional light measuring apparatus according to claim 10, wherein the light source device comprises:
a light source; and
at least one reflecting mirror that reflects the light emitted from the light source to the projecting mirror.

14. The three dimensional light measuring apparatus according to claim 1,
further comprising a light emitting unit that continuously emitting light to the light transmitting object while changing an altitude angle with respect to the light transmitting object so that the light transmitted from the light transmitting object is emitted to the incidence surface of the scattering unit,
wherein the object is a light transmitting object.
